(19) United States
(12) Patent Application Publication
(10) Pub. No.: US 2015/0360444 A1
(43) Pub. Date: Dec. 17, 2015

(54) METHOD FOR THE PRODUCTION OF AN ALUMINIZED PACKAGING STEEL

(71) Applicants: THYSSENKRUPP RASSELSTEIN GMBH, Andernach (DE); THYSSENKRUPP AG, Essen (DE)

(72) Inventors: Dirk GADE, Koblenz (DE); Reiner SAUER, Heimbach-Weis (DE); Burkhard KAUP, Andernach (DE); Manuel KÖHL, Mending (DE)

(21) Appl. No.: 14/730,606

(22) Filed: Jun. 4, 2015

(30) Foreign Application Priority Data
Jun. 13, 2014 (DE) 10 2014 108 335.0

(51) Int. Cl. B32B 15/01; C21D 9/46; C21D 6/00; C22C 38/54; C22C 38/50; C22C 38/48; C22C 38/46; C22C 38/44; C22C 38/42; C22C 38/06; C22C 38/04; C22C 38/02; C22C 38/00; C23C 2/02; C23C 2/12; C23C 2/16; C23C 2/28; C23C 2/26; C21D 8/02; C21D 1/42

(52) U.S. Cl. CPC B32B 15/012; C21D 1/42; C21D 9/46; C21D 6/004; C21D 6/005; C21D 6/008; C22C 38/54; C22C 38/50; C22C 38/48; C22C 38/46; C22C 38/44; C22C 38/42; C22C 38/06; C22C 38/04; C22C 38/02; C22C 38/008; C22C 38/001; C23C 2/02; C23C 2/12; C23C 2/16; C23C 2/28; C23C 2/26; C21D 8/0205

(57) ABSTRACT

The invention concerns a method for the production of an aluminized packaging steel from a cold-rolled steel sheet made of an unalloyed or low-alloy steel with the following steps: a. heating of the steel sheet by electromagnetic induction at temperatures in the recrystallization range of the steel at a heating rate of more than 75 K/s, so as to anneal the steel sheet in a recrystallizing manner; b. dipping of the steel sheet annealed in a recrystallizing manner into a molten aluminum bath, so as to apply an aluminum layer on the steel sheet, wherein the steel sheet, upon being dipped into the aluminum bath, has a temperature of at least 700° C.; and c. pulling the steel sheet out of the aluminum bath and cooling the aluminized steel sheet at a cooling rate of at least 100 K/s. The aluminized steel sheets are characterized by a high degree of strength and elongation at break and exhibit excellent formation characteristics, for example, in drawing and wall ironing processes, for the production of two-part food and beverage cans or lids and can be used as substitute material for tin sheets.

### FIELD OF THE INVENTION

The invention concerns a method for the production of an aluminized packaging steel from a cold-rolled steel sheet made of an unalloyed or low-alloy steel.

### BACKGROUND

Aluminum-coated (aluminized) steel sheets have been known for a long time and are, for example, produced by the application of liquid aluminum in a hot-dip process (known as hot-dip aluminizing) or also by rolling on an aluminum film, by coating through the application of an aluminum-containing precursor, such as an aluminum alkyl. In the known methods for hot-dip aluminizing of steel sheets, the steel sheet is, as a rule, heated in a furnace, for example, an annealing furnace, and then dipped into a molten aluminum bath at a bath temperature in the area of ca. 620° C. By using aluminum as a coating material on steel sheets and strips, it is possible, for example, to dispense with the more expensive tin, which is limited in its abundance, as a corrosion-resistant coating metal.

From U.S. Pat. No. 3,820,368, for example, a method for the coating of a steel sheet with aluminum in a hot-dip process is known, in which a steel sheet with a Rockwell hardness of 45 to 75 (corresponding to a tensile strength of ca. 278-450 mPa) is dipped into a molten alloy plating bath, wherein the alloy plating bath contains aluminum and more than 3% silicon. The coating produced by the hot dipping of the steel plate consists of an alloy plating layer with at least 5 μm thickness and an aluminum layer with at least 5 μm thickness, wherein the total thickness of the layer lies between 8 and 25 μm. The aluminized steel sheet produced in this way can be used in a drawing and wall ironing process for the production of a box body for a two-part beverage can.

Higher demands are being increasingly made on the characteristics of metal materials for the production of packagings, in particular, with regard to their formability and their strength.

The steel sheets used in the method of U.S. Pat. No. 3,820,368, with a Rockwell hardness (H_{R}B) of 45 to 75, do not meet the demands with regard to strength and elongation at break of packaging steels for many uses.

### SUMMARY

In one embodiment, a tin-free packaging steel is disclosed, which, with regard to its corrosion resistance, strength, and formability, is comparable to the tin sheets used from the state of the art for packaging purposes. The desired packaging steel should continue to have, in addition to a high corrosion resistance and a high strength, good formability qualities, in particular for the drawing and wall ironing process, to be suitable, for example, for the production of two-part food and beverage cans. Furthermore, the surface of the packaging steel should be as uniform as possible and have a pleasant appearance. In the drawing and wall ironing of the packaging steel, for example, in the production of cans, the lowest possible material wear and tear should be guaranteed. The packaging steel should also have good sliding characteristics and guarantee a good adhesion for organic coatings, such as those made of PP or PET, or organic lacquers, during formation in drawing and wall ironing processes.

In a method in accordance with the invention, a cold-rolled steel sheet made of an unalloyed or low-alloy, and in particular low-carbon steel, which preferably has a carbon content of 0.01-0.1 wt %, is first annealed, in a recrystallizing manner, in a first step, in that the steel sheet is heated by means of electromagnetic induction at temperatures in the recrystallization range of the steel, and preferably at temperatures above the Acl temperature, in particular in the temperature range of 700-850° C., at a heating range of more than 75 K/s. Subsequently, in a second step, the steel sheet is dipped into a molten aluminum bath while still heated so as apply an aluminum layer onto the steel sheet in the hot-dip process, wherein the steel sheet has a temperature of at least 700° C. when it is immersed in the aluminum bath. The steel sheet is then drawn out of the aluminum bath in a third step and quenched at a cooling rate of at least 100 K/s, in that the steel sheet is, for example, introduced into a quenching bath.

By the thermal treatment of the steel sheet and in particular the recrystallizing annealing by means of electromagnetic induction at a very high heating rate of more than 75 K/s and preferably at temperatures above the Acl temperature, and the final quenching of the aluminized steel sheet at a high cooling rate of at least 100 K/s, a multiphase structure is formed in the steel sheet; it comprises ferrite and at least one of the structure components martensite, bainite, and/or residual austenite. Preferably, the multiphase structure is more than 80%, and with particular preference, at least 95%, of the structural components ferrite, martensite, bainite, and/or residual austenite. Such a steel sheet with a multiphase structure is characterized by a high degree of strength of at least 500 mPa, and preferably more than 650 mPa, and a high degree of elongation at break of more than 5%, and preferably more than 10%. The aluminized steel sheet is very suitable for the production of packagings as a result of the high degree of strength and elongation at break, for example, by means of drawing and wall ironing or other suitable formation techniques.

In the hot dip process of the steel sheet, an alloy intermediate layer is formed in the boundary area between the steel sheet surface and the aluminum layer placed by the hot dip process; this intermediate layer is formed by a ternary iron-aluminum-silicon layer. This alloy layer guarantees a high degree of adhesion of the aluminum layer on the steel sheet. For the improvement of the adhesion of the aluminum layer on the steel sheet, silicon is appropriately added to the molten aluminum bath, in particular in a fraction of ca. 10 wt %. Preferably, however, an aluminum bath with pure aluminum is used for the hot dipping of the steel sheet, wherein the aluminum content of the pure aluminum bath is at least 98 wt %, and preferably more than 99 wt %, and in particular ca. 99.5 wt %. If an aluminum bath with pure aluminum is used for the hot dipping of the steel sheet, a silicate coating is applied on the surface of the steel sheet before the recrystallizing annealing, so as to guarantee a good degree of adhesion and limited alloy layer thickness of the aluminum layer on the steel sheet surface to be subsequently applied in the hot dip process. Appropriately, the application of the silicate coating on the surface of the steel sheet takes place in a cleaning step that is carried out before the recrystallizing annealing of the steel sheet, in that the steel sheet is introduced into a silicate-containing cleaning bath.

The thickness of the aluminum layer applied on the steel sheet in the hot-dip process is adjusted in the method with a stripping gas jet, with which, after the taking the steel sheet out of the aluminum bath, excess and also molten aluminum are stripped from the surface, and in particular are blown away with a gas flow. After the stripping away of excess coating material, the aluminized steel sheet is introduced, for the quenching, into a quenching bath with a cool quenching liquid. The quenching bath is appropriately formed by a tank filled with water. Cooling rates of more than 400 K/s can hereby be attained. Also, a gas jet cooling is possible with cooling rates of up to 300 K/s. The thickness of the aluminum layer placed on the steel sheet in the hot-dip process can thus be adjusted to layer thicknesses in the range of 1-15 μm, and preferably between 1 and 10 μm.

To avoid oxidations on the surface of the steel sheet or the applied aluminum coating, the introduction of the heated steel sheet into the aluminum bath and the removal from the aluminum bath take place in an inert, reducing atmosphere, for example, a protective gas atmosphere. For this, the aluminum bath is appropriately situated in an inert chamber with a protective gas atmosphere, and the steel sheet annealed in a recrystallizing manner is introduced from an annealing furnace, in particular, a continuous annealing furnace (D-furnace), which also has an inert atmosphere, directly into the inert chamber, and there is conducted into the molten aluminum bath. Also, after the removal of the steel sheet from the aluminum bath, the steel sheet is kept in an inert atmosphere until introduction into the quenching tank, so as to avoid the formation of oxides on the surface of the applied aluminum coating.

After the quenching of the aluminized steel sheet, this is appropriately finished or rerolled, wherein during the finishing, a degree of finishing of preferably 0.5-2% can be attained, and with rerolling, a degree of rerolling of more than 2% and up to 50%. Finishing (or finishing-rolling) is hereby understood to mean a pressure treatment of the aluminum-coated surface of the steel sheet with cylinders or rollers, which are pressed against the surface of the aluminum coating, wherein during finishing, an only insubstantial thickness reduction of the steel sheet of a maximum of 2% takes place. Rerolling, on the other hand, is understood to be a pressure treatment of the aluminum-coated surface of the steel sheet with cylinders or rollers (supplementary to the cold rolling already carried out before the coating), in which a substantial thickness reduction of the steel sheet is attained, which is at least greater than 2% and can be up to 50%. After the coating of the steel sheet with aluminum and the quenching, it is thereby possible to carry out only a finishing (finishing-rolling) or only a rerolling or, also in a rolling mill, to first carry out a rerolling with degrees of rerolling in the range of 3-50%, and subsequently a finishing with a finer finishing roller. By means of the finishing or rerolling of the aluminum-coated surface of the steel sheet, aluminum structures on the surface of the coating are evened out and disturbing aluminum oxides are removed. Furthermore, by the finishing or rerolling, a shiny surface of the aluminum coating is produced, which is of great importance, in particular, for the intended use of the sheets produced in accordance with the invention for the production of packagings in the food area, since a high brilliance of the surface of the packaging material is desired there. In comparison to known tin sheets, the surface of the aluminized steel sheet proves to be more attractive than the (darker) tin surface of a tin sheet because of the brightness of the aluminum coating. The finishing or rerolling produces, moreover, a finely structured surface of the aluminum coating with uniform characteristics, which guarantees a good wettability of lubricants and lacquers.

By the finishing or rerolling, aluminum unevenness or disturbing aluminum oxides, which can interfere during a lacquering or coating of the surface and can lead to coating or lacquering flaws, in particular on the surface of the aluminum coating, are removed. The aluminized steel sheets produced in accordance with the invention are therefore also very suitable for a subsequent lacquering, in particular with organic lacquers, or for the application of an organic coating, for example, a coating of PP or PET. It has also been shown that by means of the finishing or rerolling of the aluminized steel sheet, the surface of the aluminum coating is evened out and condensed, with the result of a lesser tendency of the surface for the formation of undesired oxides.

In an expedient embodiment example of the method in accordance with the invention, the aluminized steel sheet is subjected, after the quenching, to a finishing step, in that the surface of the aluminized steel sheet is finished using finer finishing rollers. It has been shown that with the finishing step, the strength of the aluminized steel sheet can be increased considerably, in particular to values of 600 mPa to 1000 mPa. It is thereby also possible to roll the aluminized steel sheet in a rerolling step first, in which, appropriately, a thickness reduction of the aluminized steel sheet to degrees of rerolling of 4% to 45% takes place, and after this rerolling step, a finishing with finer finishing rollers is to be carried out.

The method in accordance with the invention proves to be economical with resources, because the steel sheet annealed in a recrystallizing manner is introduced immediately after the recrystallization annealing, preferably in an inert chamber, into the molten aluminum bath, without a cleaning of the steel sheet surface by rinsing and pickling being required before the coating of the steel sheet by hot dipping into the aluminum bath. In known methods for the coating of steel sheets with a metal coating, for example, in electrolytic tin plating processes of steel sheets, a rerolling frequently takes place first after the recrystallization annealing for the improvement of the formation behavior; the surface of the steel sheet is contaminated and for the removal of the contamination, finishing and pickling are carried out before the steel sheet can be covered with a metal coating in a coating process (for example, galvanically or by hot dipping). In the method in accordance with the invention, this cleaning step before the coating with aluminum can be dispensed with, since any required rerolling or finishing of the steel sheet takes place only after the coating with aluminum.

Conducting of method in accordance with the invention is also advantageous with regard to energy aspects, because the reheating of the steel sheet annealed in a recrystallizing manner can the utilized in the subsequent coating step during the dipping of the steel sheet into the molten aluminum bath. The steel strip annealed in a recrystallizing manner is introduced into the hot aluminum bath while still hot, at temperatures of the steel sheet of at least 700° C.; by the introduction of the hot steel sheet, it can be maintained at least at temperatures above the melting temperature of the aluminum (660° C.), and preferably in a temperature range around 750° C.

### BRIEF DESCRIPTION OF THE DRAWINGS

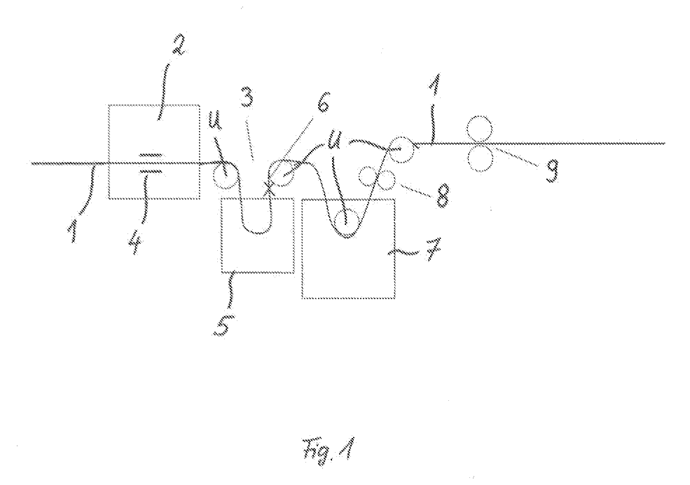

These and other advantages of the method in accordance with the invention and the steel sheet produced in accordance with the invention can be deduced from the embodiment examples described in more detail below, with reference to the accompanying drawing. The drawing of FIG. 1 thereby shows a schematic representation of a device to carry out the method in accordance with the invention.

### DETAILED DESCRIPTION OF PREFERRED EMBODIMENTS

A suitable starting material for the method in accordance with the invention is a hot-rolled and unalloyed or low-alloy steel sheet with a low carbon content of preferably less than 0.1 wt % and, in particular, between 20 and 900 ppm carbon. The alloy components of the steel appropriately meet the specifications of the international standard ASTM A 623-11 (Standard Specification for Tin Mill Products), wherein a use of the sheets produced in accordance with the invention is ensured for the production of food packagings.

Basically, all types of steel that have a composition suitable for the production of fine or very fine sheets can be used for the method in accordance with the invention. Unalloyed or low-alloy types of steel that, in addition to a low carbon fraction, also have other alloy components in low concentrations, have proved particularly suitable because of cost considerations. By means of the thermal treatment in accordance with the invention, steel sheets with a multiphase structure, which are characterized by a high degree of strength and elongation at break, can also be produced from such types of steel.

The steel used for the production of the steel sheet in accordance with the invention appropriately has less than 0.5 wt %, and preferably less than 0.4 wt % manganese, less than 0.04 wt % silicon, less than 0.1 wt % aluminum, and less than 0.1 wt % chromium. The steel can contain alloy additives of boron and/or niobium and/or titanium, so as to increase the strength, wherein the alloy of boron is appropriately in the range of 0.001-0.005 wt % and the alloys of niobium or titanium, in the range of 0.005-0.05 wt %. Preferably, however, weight fractions for Nb are thereby <0.03%.

For the production of embodiment examples of the steel sheet in accordance with the invention for use as packaging material, it is possible, for example, to use steel strips made in continuous casting and hot-rolled and wound on coils, made of low-carbon steels with the following upper limits (in wt %) for the fractions of the alloy components:

C: max. 0.1%;

N: max. 0.02%;

Mn: max. 0.5%, preferably less than 0.4%;

Si: max. 0.04%, preferably less than 0.02%;

Al: max. 0.1%, preferably less than 0.05%;

Cr: max. 0.1%, preferably less than 0.05%;

P: max. 0.03%;

Cu: max. 0.1%;

Ni: max. 0.1%;

Sn: max. 0.04%;

Mo: max. 0.04%;

V: max. 0.04%;

Ti: max. 0.05%, preferably less than 0.02%;

Nb: max. 0.05%, preferably less than 0.02%;

B: max. 0.005%

and other alloys and impurities: max. 0.05%,

the remainder iron.

It was determined that it is possible to dispense with the addition of alloy components, which are typically contained in dual phase steels, such as the addition of manganese (which, in the known dual phase steels, typically has a weight fraction of 0.8-2.0%), silicon (which, in the known dual phase steels, typically has a weight fraction of 0.1-0.5%), and aluminum (which, in the known dual phase steels, is added with a weight fraction of up to 0.2%), if a cold-rolled steel sheet with a carbon content of less than 0.1 wt % is first annealed at a heating rate of more than 75 K/s by means of electromagnetic induction, in a recrystallizing manner (or austenitizing manner), and is later quenched at a high cooling rate of 100 K/s, and appropriately more than 400 K/s.

The hot-rolled steel strip 1 is continuously passed at a transport speed of preferably more than 200 m/min and up to 750 m/min in the device shown schematically in FIG. 1 to carry out the method in accordance with the invention as an endless strip of a transport device (not depicted here) and is first cleaned in a pretreatment step, by pickling, rinsing, and drying, and subsequently, cold-rolled in a cold rolling device (not depicted here). In the cold rolling step, the thickness of the steel strip is reduced to values of less than 1.0 mm (fine sheet) or in the area of 0.05 to 0.5 mm (very fine sheet).

After the cold rolling, the steel strip is conducted through a cleaning bath in a pretreatment step. Appropriately, the cleaning bath contains a silicate, so as to provide the surface of the steel strip in the pretreatment step with a silicate coating. A suitable composition of the cleaning bath contains, for example, sodium hydroxide in a concentration of ca. 20 g/L, silicon in a concentration of 3-10 g/L, and also a wetting agent. The silicate coating thus applied preferably contains a silicon overlay of 3-10 mg/m² (Si fraction). The silicate overlay can also be applied in a separate process step, [but] the application of the silicate overlay in a pretreatment step in which the steel sheet is also cleaned, however, proves to be advantageous for reasons having to do with efficiency.

After the cold rolling and the cleaning, the cleaned steel strip 1, as schematically shown in FIG. 1, is conducted at the transport speed through a furnace 2, in particular through a continuous annealing furnace with induction heating. A heating device 4, in particular an induction heating with induction coils, is located in furnace 2. In the heating device 4, the steel strip is heated inductively, preferably in an inert protective gas atmosphere, at a heating rate of more than 75 K/s to temperatures in the recrystallization range of the used steel and, in particular, in the range of 700° C. to 850° C., and preferably to ca. 750° C., so as to anneal the cold-rolled steel strip 1 in a recrystallizing manner. In connection with the subsequently carried out quenching of the steel sheet, it is possible, by means of the recrystallizing annealing, to form a multiphase microstructure in the steel that leads to high degrees of strength and a high elongation at break.

There is an inert chamber 3 downstream from the furnace 2. The inert chamber 3 is filled with an inert reducing gas, for example, a protective gas such as nitrogen, argon, or HNx. In the inert chamber 3, there is a tank 5, which is filled with a molten aluminum bath. The molten aluminum bath has a temperature at least above the melting temperature of the aluminum (660° C.), and preferably a temperature of more than 700° C. The maintenance of preferred bath temperatures of the aluminum bath of more than 700° C. and, with particular preference, of ca. 750° C. is appropriate thereby for the desired formation of a multiphase microstructure in the steel sheet. The aluminum bath in one embodiment example of the invention is a bath with pure, molten aluminum, wherein the aluminum content is at least 98 and preferably more than 99%. In a preferred embodiment example, the aluminum content of the aluminum bath is ca. 99.5%.

In an alternative embodiment example, the molten aluminum bath can also be an aluminum alloy, which, in addition to the main component aluminum, also contains a fraction of silicon in the range of 5 to 13%, and preferably 9 to 11% and, perhaps, other fractions. In a preferred embodiment variant, the aluminum bath contains 10% silicon, 3% iron, and the remainder consists of aluminum. The addition of other alloy components, such as magnesium with a weight fraction of 0.2-6%, is also possible here.

A gas stripping jet 6 is located downstream from the tank 5 filled with the molten aluminum bath. With the gas stripping jet 6, any molten and excess aluminum is stripped from the surface of the steel sheet 1 and is blown off, in particular by means of a gas flow. By means of the gas stripping jet 6, the cover thickness of the aluminum coating can be adjusted to desired values in the range of 1 to 15 μm. This takes place appropriately by a pressure-regulated blowing on of an inert gas, such as nitrogen, on both sides of the aluminum-coated steel strip 1 over the entire strip width, wherein excess aluminum is stripped off. A closed control loop thereby guarantees a uniform aluminum overlay over the entire strip width and strip length. A different aluminum overlay can also be adjusted thereby on the two sides of the steel strip 1 (with a difference overlay).

The steel strip 1 coming from furnace 2 is first conducted into the inert chamber 3 and there, with a deflection around a deflection roller U, conducted into tank 5 with the aluminum bath and, again, taken out of the aluminum bath. After deflection of the steel strip 1 around another deflection roller U, the then aluminum-coated steel sheet 1 is conducted into a quenching tank 7 filled with a cooling fluid, in particular a quenching liquid such as water. In this way, the steel strip 1 is cooled to room temperature at high quenching rates of preferably more than 400 K/s. The cooling of the steel strip can also take place by means of a gas flow.

Downstream from the quenching tank 7, the cooled steel strip 1 runs through a pair of squeezing rollers 8, which squeeze the adhering quenching liquid from the surface of the aluminum-coated steel strip 1. After the squeezing of the quenching liquid, a drying can be carried out if necessary. After another deflection around a deflection roller U, the aluminized and cooled steel strip 1 is conducted into a finishing mill or a rolling mill 9. The aluminum-coated surface of the steel strip 1 is finished or rolled in the finishing mill or the rolling mill 9, wherein during the finishing, preferably a degree of finishing of 0.5 to 2% can be attained, and with a rolling mill, a degree of rolling of more than 2% and up to 50%. It is not necessary thereby for the mills for the rolling or finishing to be arranged in a line with the aluminum coating, that is, the rolling mill or the finishing mill can also be made separately from the unit for the immersion coating of the steel sheet.

By means of the finishing or rolling, aluminum oxides on the aluminum coating are removed. In order to prevent a renewed oxidation of the aluminum coating after the finishing or rerolling, a passivation of the aluminum-coated surface of the steel strip can be appropriately carried out. A surface of the aluminized steel strip that is as oxide-free as possible guarantees good sliding characteristics during the formation, for example, in drawing and wall ironing processes, and for this reason, the required use of lubricants can thereby be kept low.

In comparison to tin sheets with a tin-plated surface, the aluminized steel strip in accordance with the invention, however, has reduced sliding characteristics. To improve the sliding characteristics of the aluminized steel sheet in the processing methods below, therefore, the use of lubricants such as, for example, DOS (dioctyl sebacate), is generally required.

The aluminum wear, usually appearing in the formation methods below, which, for example, appears in the production of cans made of aluminized steel sheets in drawing and wall ironing processes, can be minimized in the steel sheets in accordance with the invention in that in a final finishing step, a dry brilliance finishing of the aluminum-coated surface takes place, wherein a high condensation of the aluminum coating can be attained, which minimizes the wear of aluminum in formation processes.

In the transfer of the steel strip 1, heated in furnace 2 and annealed in a recrystallizing manner, from furnace 2 into the aluminum bath (tank 5), the steel strip 1 is preferably kept in an inert protective gas atmosphere, without the surface of the heated steel strip 1 coming into contact with air oxygen. Upon introducing the steel strip 1 into the molten aluminum bath, the steel strip has a temperature of more than 700° C.

Also, in the transfer from the molten aluminum bath into the quenching tank 7, the steel strip 1 then provided with the aluminum coating is conducted in the inert protective gas atmosphere of the inert chamber 3, without the aluminum coating (which is still partially molten) being able to come into contact with air oxygen. In this way, both an oxidation of the still uncoated and cleaned steel strip surface and also the aluminum coating applied in the aluminum bath is prevented.

The aluminized steel sheets produced in accordance with the invention exhibit excellent formation characteristics, for example, in drawing and wall ironing processes, for the production of two-part food and beverage cans or of lids.

1. Method for the production of aluminized packaging steel made from a cold-rolled steel sheet of an unalloyed or low-alloy steel with the following steps:
heating of the steel sheet by means of electromagnetic induction at temperatures in the recrystallization range of the steel at a heating rate of more than 75 K/s, so as to anneal the steel sheet in a recrystallizing manner;
dipping of the steel sheet, annealed in a recrystallizing manner, into a molten aluminum bath, so as to apply an aluminum layer on the steel sheet, wherein the steel sheet, when dipped into the aluminum bath, has a temperature of at least 700° C.;
taking the steel sheet out of the aluminum bath and cooling of the aluminized steel sheet at a cooling rate of at least 100 K/s.

2. Method according to claim 1, wherein upon cooling the aluminized steel sheet, a multiphase structure is formed in the steel, which comprises ferrite and at least one of the structural components martensite, bainite, and/or residual austenite, wherein the multiphase structure is preferably more than 80%, and with particular preference, at least 95% of the structural components ferrite, martensite, bainite, and/or residual austenite.

3. Method according to claim 1, wherein the cooling rate at which the steel sheet is cooled after the application of the aluminum sheet is greater than 400 K/s and, preferably, greater than 500 K/s.

4. Method according to claim 1, wherein the steel sheet is produced from a low-alloy steel with a carbon fraction of 0.01 to 0.1 wt % and the following upper limits for the weight fraction of the other alloy components:
N: max. 0.02%;
Mn: max. 0.4%;
Si: max. 0.04%;
Al: max. 0.1%;
Cr: max. 0.1%;
P: max. 0.03%;
Cu: max. 0.1%;
Ni: max. 0.1%;
Sn: max. 0.04%;
Mo: max. 0.04%;
V: max. 0.04%;
Ti: max. 0.05%, preferably less than 0.02%;
Nb: max. 0.05%, preferably less than 0.02%;
B: max. 0.005% P1 and other alloys and impurities: max. 0.05%.

5. Method according to claim 1, wherein the steel sheet is dipped, after being pulled out of the aluminum bath, into a quenching liquid or is cooled with a gas flow.

6. Method according to claim 1, wherein the steel sheet is heated inductively, during the recrystallizing annealing, at temperatures in the range of 700° C. to 780° C., and in particular at 740° C. to 760° C.

7. Method according to claim 1, wherein the molten aluminum bath contains an aluminum alloy with a silicon fraction of 5 to 13 wt %, and preferably 9 to 11 wt %.

8. Method according to claim 1, wherein the molten aluminum bath consists at least essentially of pure aluminum and preferably contains an aluminum content of at least 98 wt %, and preferably of at least 99 wt %, and in particular 99.5 wt %.

9. Method according to claim 8, wherein a silicate coating is applied on the steel sheet before the recrystallizing annealing.

10. Method according to claim 1, wherein the steel sheet is conducted through a cleaning bath before the recrystallizing annealing, wherein a silicate coating is applied on the steel sheet.

11. Method according to claim 1, wherein the thickness of the applied aluminum layer (including an intermediate alloy layer) is between 1 and 15 μm, and preferably between 1 and 10 μm.

12. Method according to claim 1, wherein after pulling the steel sheet out of the aluminum bath, excess and still molten aluminum is stripped or blown off by means of a gas stripping jet, so as to adjust the thickness of the applied aluminum layer to the desired value and to make it uniform over the surface of the steel sheet.

13. Method according to claim 1, wherein the steel sheet is finished and/or rerolled cold after the cooling, wherein during the finishing, preferably a degree of finishing of 0.5-2.0% is attained and/or during the rerolling, a degree of rerolling of more than 2% and up to 50%.

14. Method according to claim 1, wherein the recrystallizing annealing, the aluminum layer application and the quenching of the aluminized steel sheet take place in an inert reducing atmosphere, wherein, preferably, the molten aluminum bath and a quenching tank are located in an inert chamber with a protective gas atmosphere and the steel sheet is conducted into the inert chamber after the recrystallizing annealing and, there, is conducted into the molten aluminum bath and is subsequently pulled out of the aluminum bath and conducted into the quenching tank.

15. Method according to claim 1, wherein the steel has
a carbon content of 0.01 to 0.1%;
a manganese content of less than 0.4 wt %;
a silicon content of less than 0.04 wt %;
an aluminum content of less than 0.1 wt %;
and a chromium content of less than 0.1 wt %.

16. Method according to claim 1, wherein the steel sheet is a cold-rolled fine or very fine sheet made of a low-alloy steel, which contains boron and/or niobium, and/or titanium.

17. Method according to claim 1, wherein after the cooling, the steel sheet has a tensile strength of at least 500 mPa, preferably more than 650 mPa, and an elongation at break of more than 5%, preferably of more than 10%.

18. Method according to claim 1, wherein the recrystallizing annealing takes place over a time interval of 0.5 to 1.5 seconds, preferably of ca. 1 second.

19. Use of an aluminized steel sheet, produced with a method according to claim 1, as a packaging steel, in particular for the production of cans for food, beverages, and other fillers, such as chemical or biological products, and for the production of aerosol containers and closures.
